(19) United States
(12) Patent Application Publication
(10) Pub. No.: US 2025/0128899 A1
(43) Pub. Date: Apr. 24, 2025

(54) METHODS, DEVICES, AND SYSTEMS FOR MONITORING BEARINGS IN SUCTION ROLLERS

(71) Applicant: Stowe Woodward Licensco LLC, Youngsville, NC (US)

(72) Inventors: Jacob Speckman, Neenah, WI (US); Wesley C. Van Pelt, Appleton, WI (US)

(21) Appl. No.: 18/820,656

(22) Filed: Aug. 30, 2024

Related U.S. Application Data
(60) Provisional application No. 63/591,801, filed on Oct. 20, 2023.

(51) Int. Cl. B65H 5/22; G01M 13/04

(52) U.S. Cl. CPC B65H 5/226; G01M 13/04; B65H 2406/33; B65H 2513/20; B65H 2515/40

(57) ABSTRACT

An electronic device for monitoring a suction roller includes a bearing module configured to monitor a bearing of the suction roller. The bearing module includes an accelerometer and a temperature circuit that are configured to monitor positioning and temperature, respectively, of the bearing of the suction roller. The bearing module includes an enclosure that has both the accelerometer and the temperature circuit therein. Related methods and systems are also described.

### CROSS-REFERENCE TO RELATED APPLICATION

The present application claims the benefit of U.S. Provisional Patent Application No. 63/591,801, filed Oct. 20, 2023, the disclosure of which is herein incorporated in its entirety by reference.

### FIELD

Various embodiments described herein relate to paper machine suction roller devices, and more specifically to monitoring bearings of suction rollers including parameters such as vibration and/or temperature.

### BACKGROUND

Suction rollers, also referred to as nipped rolls or pinch rolls, are used in a vast number of continuous process industries including papermaking, steel making, plastics calendering, and/or printing. Suction rollers are used to press two or more sheets of a material together. The characteristics of suction rollers may be particularly important in papermaking. Two or more suction rollers may press together, exerting force on the paper or types of sheets therebetween. Various sensors may be used to monitor the pressure, temperature, wear, or other characteristics of the suction rollers during operation.

### SUMMARY

Various embodiments of the present inventive concepts are directed to an electronic device for monitoring a suction roller. The electronic device includes a bearing module configured to monitor a bearing of the suction roller. The bearing module includes an accelerometer and a temperature circuit that are configured to monitor positioning and temperature, respectively, of the bearing of the suction roller. The bearing module includes an enclosure that includes both the accelerometer and the temperature circuit therein.

According to some embodiments, the accelerometer may include a piezoelectric accelerometer that is configured to monitor the suction roller. The piezoelectric accelerometer may include a 3-axis piezoelectric accelerometer configured to measure acceleration along an x-axis, a y-axis, and a z-axis.

According to some embodiments, the bearing module may further include a microcontroller that is configured to transmit acceleration data from the accelerometer and temperature data from the temperature circuit to an external control unit that is external to the suction roller. The bearing module may further include a cache memory. The acceleration data from the accelerometer may be sampled by the microcontroller and stored in the cache memory for future transmission to the external control unit. The acceleration data and the temperature data may be transmitted over a RS485 interface to the external control unit. The microcontroller may trigger an alert when the temperature data at the temperature circuit exceeds a threshold. The microcontroller may be configured to correlate the acceleration data and the temperature data to trigger an alert associated with faulty operation of the bearing of the suction roller. The accelerometer may be configured to measure frequencies up to 10 kHz and force up to 25 g-force.

According to some embodiments, the temperature circuit within the bearing module may be configured to monitor the temperature at a temperature sensor that is remote from the enclosure. The accelerometer within the bearing module may be configured to monitor vibrations associated with the suction roller that are localized to the enclosure. The bearing may be remote from the bearing module such that the temperature of the bearing is monitored remotely by the temperature circuit.

According to some embodiments, the enclosure includes a first port configured to receive temperature data from a temperature sensor that is remote from the enclosure, and a second port configured to transmit acceleration data from the accelerometer and temperature data from the temperature circuit. The first port is electrically connected to a plurality of wires that extend to the bearing. The plurality of wires may be in a lubricant line that extends to be adjacent to the bearing.

Various embodiments of the present inventive concepts are directed to a method for monitoring a bearing of a suction roller. The method includes monitoring, by a positioning circuit, a position of the bearing of the suction roller, and monitoring, by a temperature circuit, a temperature associated with the bearing of the suction roller. The positioning circuit and the temperature circuit are both in an enclosure that is mounted in the suction roller. The method may further include sampling acceleration data from the positioning circuit, and sampling temperature data from the temperature circuit. The method may further include transmitting data based on the acceleration data from the positioning circuit and the temperature data from the temperature circuit to an external control unit that is external to the suction roller. The method may further include receiving temperature data at a first port of the enclosure from a temperature sensor that is remote from the enclosure, and transmitting data associated with the temperature from a second port of the enclosure to an external control unit. The method may further include triggering an alert associated with faulty operation of the bearing of the suction roller based on the temperature associated with the bearing of the suction roller and a position of the bearing of the suction roller.

Various embodiments of the present inventive concepts are directed to a bearing monitoring circuit for monitoring a suction roller. The bearing monitoring circuit includes an accelerometer that is configured to monitor positioning of a bearing of the suction roller, and a temperature circuit that is configured to monitor temperature of the bearing of the suction roller. The accelerometer and the temperature circuit are in a single enclosure that is mounted in the suction roller.

### BRIEF DESCRIPTION OF THE DRAWINGS

The accompanying drawings are included to provide a further understanding of the present disclosure and are incorporated in and constitute a part of this application. These drawings illustrate certain example embodiments. In the drawings:

FIG. 1 is a perspective end view of a typical paper machine suction roller, according to various embodiments described herein.

FIG. 2 is an enlarged perspective end view of the suction box area of a typical suction roller, according to various embodiments described herein.

FIG. 3 is a suction roller, according to various embodiments described herein.

FIG. 4 is an enlarged view of a shell of a suction roller including a bearing mount, according to various embodiments described herein.

FIG. 5 and FIG. 6 are block diagrams of a suction roller monitoring system, according to various embodiments described herein.

FIGS. 7A-G illustrate components of a circuit diagram of an electronic device of a suction roller monitoring system, according to various embodiments described herein.

FIGS. 8 to 12 are flowcharts of operations of a suction roller monitoring system, according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Monitoring devices, such as temperature sensors and vibration sensors, may be placed on suction rollers to monitor operational parameters of the seal strip such as, temperature, vibration, and/or other characteristics. Specifically, due to operational stressors, the bearings in the suction roller need to be monitored for being subjected to excessive vibrations or high temperatures during operation of the suction rollers. Monitoring sensors may be part of a monitoring device that discerns these various operational parameters from the sensors and sends related information to a processor, hardware, software, firmware, and/or a user interface. The monitoring device may need to be placed inside a suction roller and needs to occupy as little space as possible.

Various embodiments of the present inventive concepts arise from the recognition of a need for a compact solution to monitor both the temperature and vibration or positioning of the bearing of the suction roller. Conventional temperature sensors and vibration sensors may each occupy a large footprint and thus may not be mounted in an effective location within the suction roller. The present inventive concepts provide a bearing module that is encased in a small enclosure that is similar in size to existing accelerometers. Conventional accelerometers typically require another box to be mounted nearby to interpret the vibration measurements and temperature readings. An advantage of the bearing module of the present inventive concepts is that it includes remote temperature monitoring and localized vibration monitoring in a same enclosure, thus offering advantages over existing accelerometers.

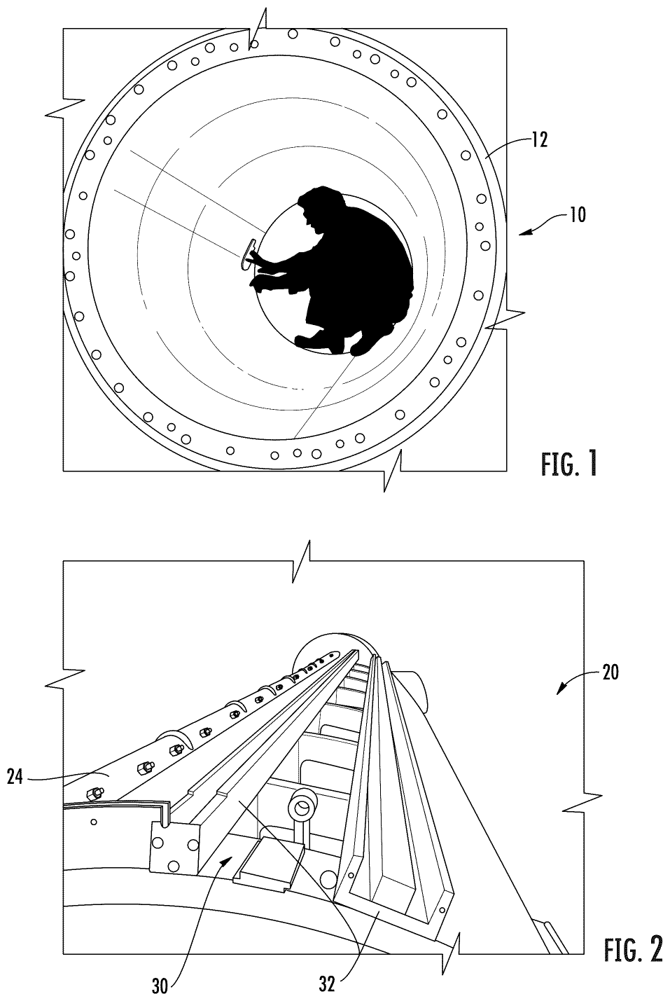

FIG. 1 is a perspective end view of a typical paper machine suction roller, according to various embodiments described herein. Referring to FIG. 1, the main component of a suction roller 10 includes a hollow shell 12 made of stainless steel, bronze or other metal that has many holes (e.g., tens of thousands of holes) drilled in a prescribed pattern radially around the circumference of the roll. These holes are gauged in size (ranging from under ⅛″ to nearly ¼″) and are engineered for the particular paper material to be processed. It is these holes that form the “venting” for water removal. This venting can typically range from approximately 20 to 45 percent of the active roll surface area. The suction roller shell is driven by a drive system that rotates the shell around a stationary core called a suction box.

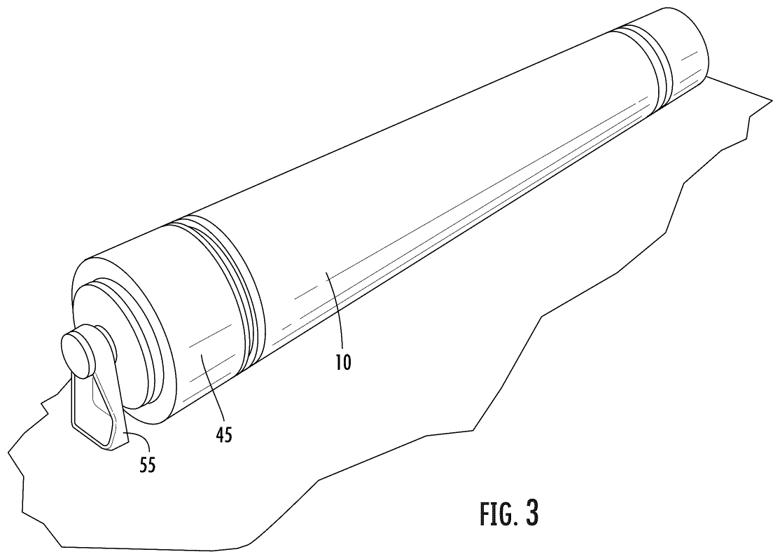

FIG. 2 is an enlarged perspective end view of the suction box area of a typical suction roller, according to various embodiments described herein. Referring to FIG. 2, the suction box 20 can be thought of as conventional long rectangular box without a lid on the top and with ports on the end, bottom or sides. The end (specifically the drive end) of the box typically has a pilot bearing; the inner raceway of the bearing is a pilot bushing or bearing with a slip fit to a journal on the suction box, and the outer raceway is pressed onto the rotating shell. The suction box 20 is connected with a suction source (e.g., a vacuum pump). An exemplary suction box and shell are shown in U.S. Pat. No. 6,358,370 to Huttunen, the disclosure of which is hereby incorporated herein in its entirety. According to various embodiments described herein, a bearing module that includes temperature monitoring and localized vibration monitoring capabilities, is mounted of a side of the shell 12 of the suction roller 10 and may extend into the shell 12.

In order to take advantage of the holes in the shell, a vacuum zone 30 must be created using these ports on the inside of the suction roller shell in a zone that is directly underneath the paper pulp that is being processed. This is accomplished by the suction box 20 using a slotted holder 32 which holds a seal along the long axis of the suction box on both sides. FIG. 2 shows the slotted holders 32, and varieties of seals may be in the form of strips (hereinafter “seal strips”). The seal strips are usually made of rubberized polymerized graphite and are held nearly in contact with the inner surface of the shell 12 during operation. Between the seal strips a constant vacuum is drawn. This allows the vacuum zone 30 to be created underneath the sheet as is passes over the suction roller 10.

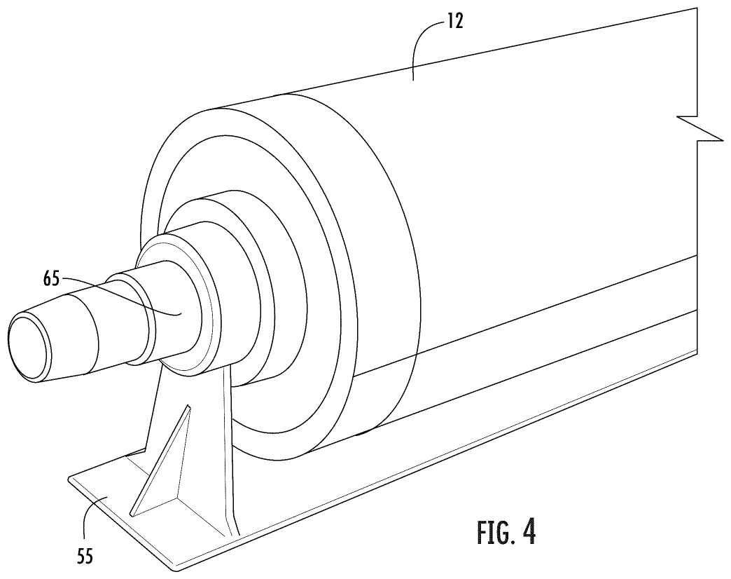

FIG. 3 is a suction roller, according to various embodiments described herein. Referring to FIG. 3, a suction roller 10 may be used to form sheets of a material, such as paper. Two or more suction rollers may press together, exerting force on the paper or types of sheets therebetween. Various sensors may be used to monitor the pressure, temperature, wear, or other characteristics of the suction roller during operation. An attachment 55 is used to attach the suction roller 10 and related assembly to the floor. A stationary unit 45 attaches to attachment 55 and includes bearings that allow the suction roller 10 to spin.

FIG. 4 is a shell 12 of a suction roller including a bearing sleeve, otherwise referred to as bearing 65, according to various embodiments described herein. Referring to FIG. 4, shell 12 of the suction roller is illustrated. The bearing 65 includes rotationally movable components that allow the shell 12 to move or rotate during operation. A bearing 65 may be on each end of the shell 12. The operation of the suction roller 10 may generate heat and/or vibration. The temperature around the bearing and the vibration caused by the operation around the bearing need to be monitored such that proper action may be taken if the temperature and/or vibration exceeds safe operating conditions. For example, the temperature of the bearing 65 may reach about 180° F. and continue safe operation of the suction roller. However, if the temperature reaches near 220° F., the lubricant around the bearing may start breaking down, which prevents smooth operation of the bearing 65 and may lead to excessive vibration of the suction roller.

A bearing module, which is an electronic device that includes temperature monitoring and localized vibration monitoring capabilities, is mounted inside a slot on an internal side of the shell 12 of the suction roller, adjacent to the bearing 65. The bearing module is stationary while the bearing of either side of the shell 12 of the suction roller rotates or spins.

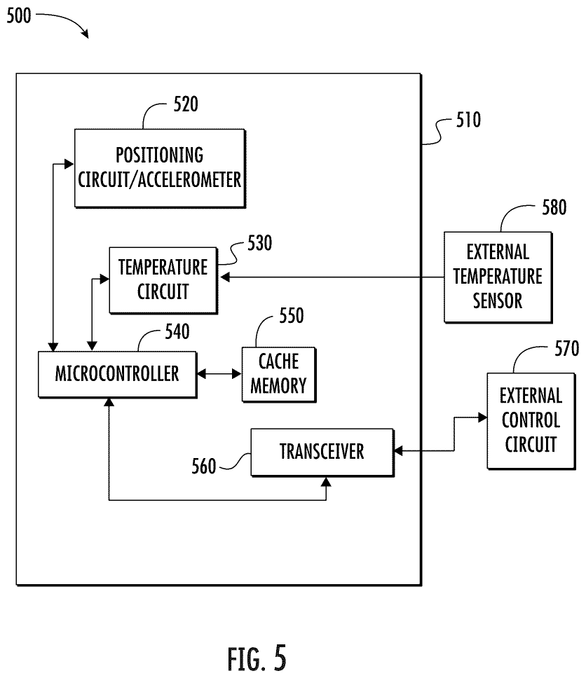

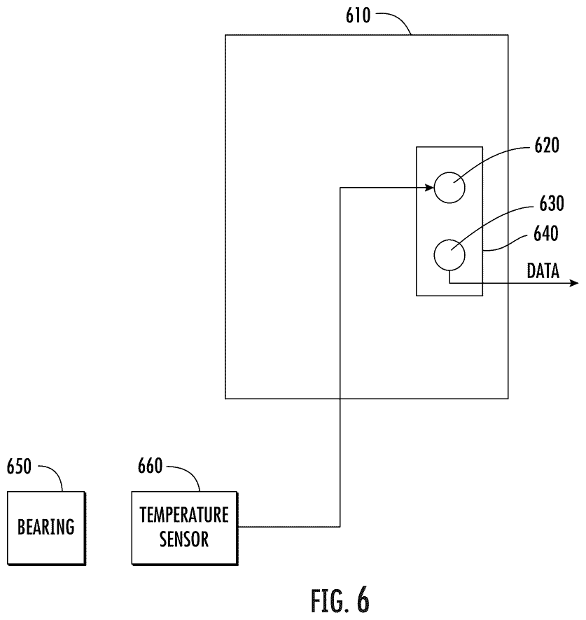

FIG. 5 and FIG. 6 are block diagrams of a suction roller monitoring system, according to various embodiments described herein. Referring to FIG. 5, a bearing module 500 is configured to monitor a bearing of the suction roller, such as suction roller 10 of FIG. 1 and/or FIG. 3. The bearing module 500 includes a positioning circuit, such as an accelerometer 520 that senses vibrations, and a temperature circuit 530 that is configured to monitor temperature of the bearing of the suction roller. The bearing module 500 has an enclosure 510 that includes both the accelerometer 520 and the temperature circuit 530 therein. The bearing module 500 includes a bearing monitor microcontroller 540, a cache memory 550, and a transceiver 560. The transceiver 560 is configured to communicate with an external control circuit 570 that is external to the enclosure 510 of the bearing module 500. The microcontroller 540 may be a processor/microprocessor and may include hardware, software, firmware, and/or a combination thereof.

Still referring to FIG. 5, an external temperature sensor 580 may be placed in close proximity to or adjacent to the bearing of the suction roller. The external temperature sensor 580 may collect temperature data from the bearing and provide to the temperature circuit 530 and/or microcontroller 540 within the enclosure. By using an external temperature sensor 580 that is co-located with the bearing of the suction roller, temperature variations of the bearing may be detected quickly, possibly before adverse effects such as vibrations are sensed by the accelerometer 520, in order to provide a warning to the machine operator earlier. In some embodiments, a temperature sensor may be located within the enclosure 510.

Still referring to FIG. 5, the microcontroller 540 may monitor each axis of the accelerometer 520 while caching the readings into the memory 550, since large amounts of memory may be used due to a fast sampling rate by the accelerometer 520. Both accelerometer data and temperature data may be available to be sent over a RS485 interface to an external control circuit 570. The accelerometer may be configured to measure frequencies up to 10 kHz and forces up to 25 g-force. The microcontroller 540 may trigger an alert when the temperature data at the temperature circuit 530 exceeds a threshold. In some embodiments, hysteresis of the temperature measurements may be provided at the microcontroller 540 before triggering alerts related to excessive temperature readings. For example, a temperature may exceed a temperature threshold for a period of time before an alert is triggered by the microcontroller 540. The alert may indicate faulty operation of the bearing of the suction roller due to excessive temperature, excessive vibration, or a combination thereof. In some embodiments, the microcontroller 540 may correlate the temperature and vibration to trigger an alert of faulty operation. In other words, an increased temperature is expected to occur in conjunction with or due to increased vibration of the suction roller.

Referring to FIG. 6, the enclosure 610 includes a first port 620 configured to receive temperature data from a temperature sensor that is remote from the enclosure 610, and a second port 630 configured to transmit acceleration data from the accelerometer (such as the positioning circuit/accelerometer 520 of FIG. 5) and/or transmit temperature data from the temperature circuit (such as temperature circuit 530 of FIG. 5). The temperature sensor may be mounted near to the bearing in order to sense the temperature of the bearing. The temperature sensor may be inside enclosure 610 or external to enclosure 610. The first port 620 may receive temperature data directly or indirectly from a temperature sensor 660 that is external to the enclosure 610. The temperature sensor 660 may be in the proximity of a bearing 650 of the suction roller.

In some embodiments, instead of plugging a temperature sensor into the first port 620, another accelerometer may be plugged into the first port 620 to have a “daisy chain” configuration that allows multiple vibration measurement points on a suction roller without needing a wire harness for each one from an external controller. Daisy chaining accelerometers can allow for the collection of better information regarding whether a specific location along the suction roller is experiencing more vibration or if the vibration is more uniform along the suction roller.

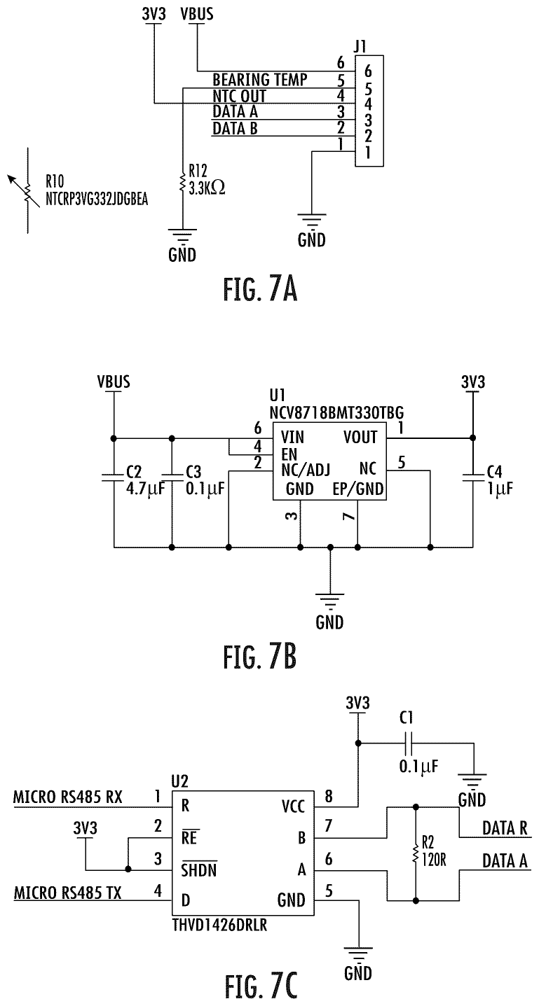

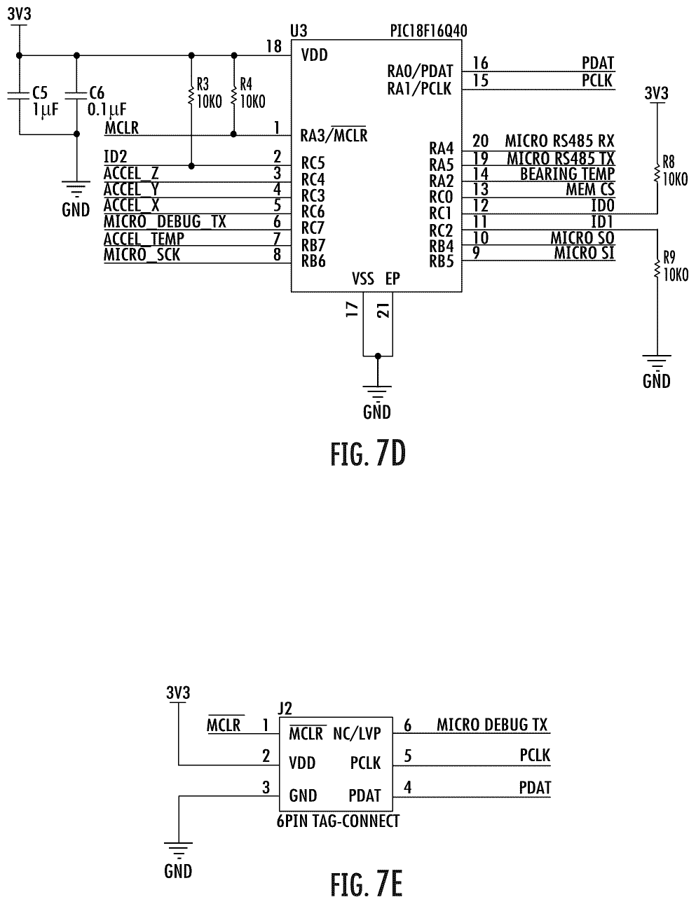

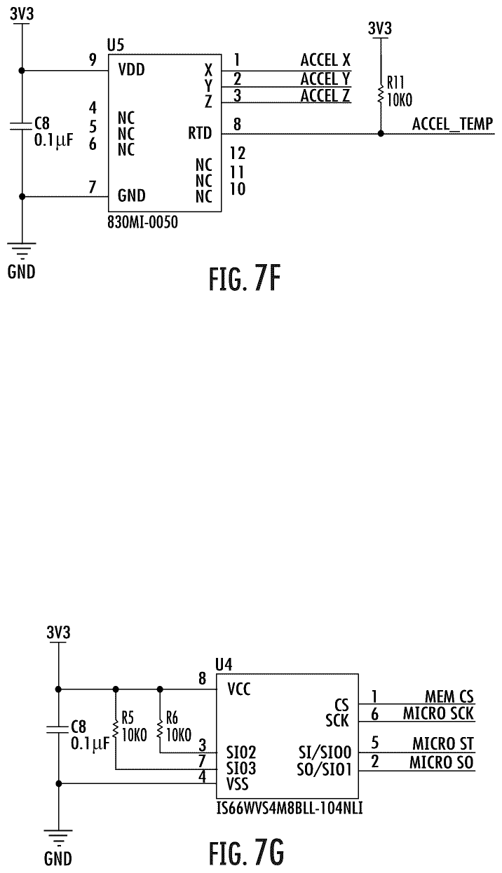

FIGS. 7A-G illustrate components of a circuit diagram of an electronic device of a suction roller monitoring system, according to various embodiments described herein. Referring to FIG. 7A, a connector J1 provides an external connection to the circuit board of the electronic device of a suction roller monitoring system. A temperature sensor R10 may include a thermistor such as a Negative Temperature Coefficient (NTC) thermistor that is a thermally sensitive semiconductor resistor which shows a sharp decrease in resistance as temperature increases. Information regarding the bearing temperature BEARING_TEMP may be received from the temperature sensor R10 that is in the proximity of the bearing, and external to the electronic device. DATA_A and DATA_B are communication lines to outside of the enclosure of the electronic device of the suction roller monitoring system to transmit and/or receive temperature data.

Referring to FIG. 7B, linear voltage regulator U1 provides, for example, a 3.3V power supply voltage to components of the electronic device of a suction roller monitoring system. The 3.3V output of linear voltage regulator U1 may be achieved by stepping down of a 12V or 24V power input.

Referring to FIG. 7C, transceiver U2 provides RS485 communication logic for communications to/from for example, transceiver 560 of FIG. 5. Specifically, acceleration data from the accelerometer and temperature data from the temperature circuit may be transmitted by transceiver U2. Referring to FIG. 7D, Microcontroller U3 performs various operations described herein, such as processing and initiating transmission of acceleration data from the accelerometer and temperature data from the temperature circuit to an external control unit that is external to the suction roller. Referring to FIG. 7E, a debug port J2 facilitates debugging of the monitoring circuit described herein.

Referring to FIG. 7F, accelerometer circuit U5 provides tri-axial sensing that may be used to determine the vibrations and/or positioning of bearings of the suction roller. Accelerometer circuit U5 may be a 3-axis piezoelectric accelerometer that senses acceleration along an x-axis, a y-axis, and a z-axis in order to provide an indication of the vibration associated with one or more bearings of the suction roller. In some embodiments, accelerometer circuit U5 may include a temperature sensor to determine the temperature within the enclosure that encompasses the electronic device of the suction roller monitoring system. The temperature information collected by the accelerometer circuit U5 may be used in conjunction with or in lieu of temperature data collected by temperature sensor R10 that is external to the enclosure.

Referring to FIG. 7G, memory U4 may provide a cache to store data that is accessed by microcontroller U3. Specifically, memory U4 may store sampled acceleration data from the accelerometer circuit U5 and/or sampled temperature data from the temperature sensor R10 and/or sampled temperature data from the temperature sensor that is part of accelerometer circuit U5. Use of the memory U4 that is external to the microcontroller allows fast sampling of temperature and/or vibration data by caching to allow the sampled data to be transmitted to the external control unit after sampling. The vibration data may be sampled by the accelerometer in several ways such as using data truncation or by oversampling at higher frequencies. For example, accelerometer data may be truncated from 12 bits to 8 bits by dropping the 4 least significant bits of the data. Sampling may be conducted at 20 kHz for each of the three channels, i.e., the x-axis, y-axis, and z-axis directions. If memory U4 is 4 MB, for example, data may be sampled for about one minute before being transmitted to an external control circuit.

FIGS. 8 to 12 are flowcharts of operations of a method of monitoring the bearing of a suction roller monitoring system, according to various embodiments described herein. Referring to FIG. 8, operations such as monitoring, by a positioning circuit, a position of the bearing of the suction roller are performed, at block 810. A temperature associated with the bearing of the suction roller is monitored by a temperature circuit, at block 820. The positioning circuit and the temperature circuit are both in an enclosure that is mounted in the suction roller.

Referring to FIG. 9, the method for monitoring the bearing of the suction roller may further include sampling acceleration data from the positioning circuit, at block 910. The method may include sampling temperature data from the temperature circuit, at block 920.

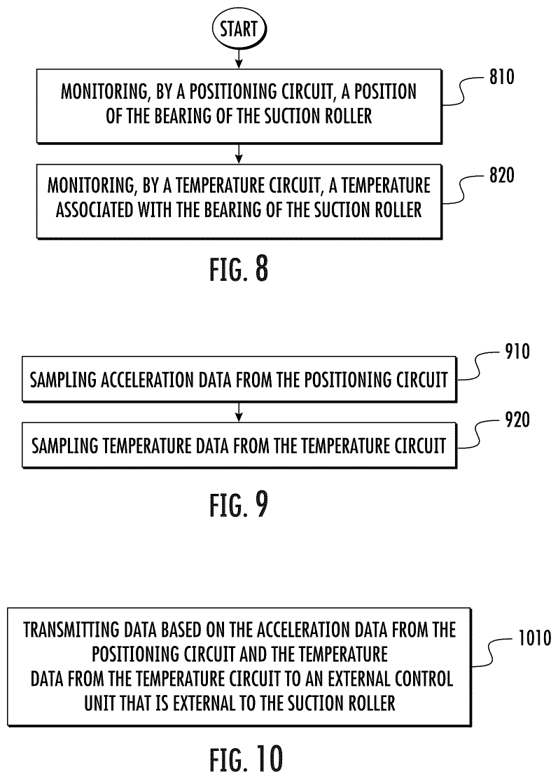

Referring to FIG. 10, the method for monitoring the bearing of the suction roller may further include transmitting data based on the acceleration data from the positioning circuit and the temperature data from the temperature circuit to an external control unit that is external to the suction roller, at block 1010.

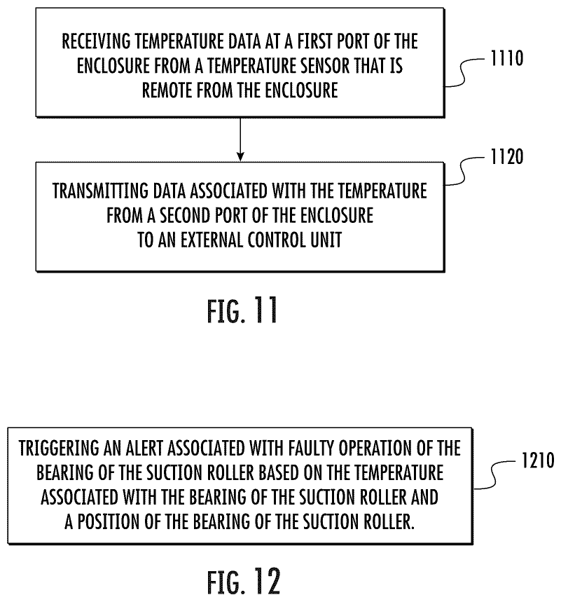

Referring to FIG. 11, the method for monitoring the bearing of the suction roller may further include receiving temperature data at a first port of the enclosure from a temperature sensor that is remote from the enclosure, at block 1110. The method may include transmitting data associated with the temperature from a second port of the enclosure to an external control unit, at block 1120.

Referring to FIG. 12, the method for monitoring the bearing of the suction roller may further include triggering an alert associated with faulty operation of the bearing of the suction roller based on the temperature associated with the bearing of the suction roller and a position of the bearing of the suction roller, at block 1210.

According to various embodiments described herein, an electronic device for monitoring a suction roller includes an enclosure that has both the accelerometer and the temperature circuit therein. Thus, the embodiments described herein may provide a convenient solution that saves space by providing a compact solution to monitor both the temperature and vibration or positioning of the bearing in the suction roller.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art, and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements, and elements should not be limited by these terms; rather, these terms are only used to distinguish one element from another element. Thus, a first element discussed could be termed a second element without departing from the scope of the present inventive concepts.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles described herein. All such variations and modifications are intended to be included herein within the scope.

1. An electronic device for monitoring a suction roller, the electronic device comprising:
a bearing module configured to monitor a bearing of the suction roller,
wherein the bearing module comprises an accelerometer and a temperature circuit that are configured to monitor positioning and temperature, respectively, of the bearing of the suction roller, and
wherein the bearing module comprises an enclosure that includes both the accelerometer and the temperature circuit therein.

2. The electronic device of claim 1, wherein the accelerometer comprises a piezoelectric accelerometer that is configured to monitor the suction roller.

3. The electronic device of claim 2, wherein the piezoelectric accelerometer comprises a 3-axis piezoelectric accelerometer configured to measure acceleration along an x-axis, a y-axis, and a z-axis.

4. The electronic device of claim 1, wherein the bearing module further comprises:
a microcontroller that is configured to transmit acceleration data from the accelerometer and temperature data from the temperature circuit to an external control unit that is external to the suction roller.

5. The electronic device of claim 4, wherein the bearing module further comprises:
a cache memory,
wherein the acceleration data from the accelerometer is sampled by the microcontroller and stored in the cache memory for future transmission to the external control unit.

6. The electronic device of claim 4, wherein the acceleration data and the temperature data are transmitted over a RS485 interface to the external control unit.

7. The electronic device of claim 4, wherein the microcontroller triggers an alert when the temperature data at the temperature circuit exceeds a threshold.

8. The electronic device of claim 4, wherein the microcontroller is configured to correlate the acceleration data and the temperature data to trigger an alert associated with faulty operation of the bearing of the suction roller.

9. The electronic device of claim 1, wherein the accelerometer is configured to measure frequencies up to 10 kHz and force up to 25 g-force.

10. The electronic device of claim 1,
wherein the temperature circuit within the bearing module is configured to monitor the temperature at a temperature sensor that is remote from the enclosure, and
wherein the accelerometer within the bearing module is configured to monitor vibrations associated with the suction roller that are localized to the enclosure.

11. The electronic device of claim 1, wherein the bearing is remote from the bearing module such that the temperature of the bearing is monitored remotely by the temperature circuit.

12. The electronic device of claim 1, wherein the enclosure comprises:
a first port configured to receive temperature data from a temperature sensor that is remote from the enclosure; and
a second port configured to transmit acceleration data from the accelerometer and temperature data from the temperature circuit.

13. The electronic device of claim 12, wherein the first port is electrically connected to a plurality of wires that extend to the bearing.

14. The electronic device of claim 13, wherein the plurality of wires are in a lubricant line that extends to be adjacent to the bearing.

15. A method for monitoring a bearing of a suction roller, the method comprising:
monitoring, by a positioning circuit, a position of the bearing of the suction roller; and
monitoring, by a temperature circuit, a temperature associated with the bearing of the suction roller,
wherein the positioning circuit and the temperature circuit are both in an enclosure that is mounted in the suction roller.

16. The method for monitoring the bearing of the suction roller of claim 15, the method further comprising:
sampling acceleration data from the positioning circuit; and
sampling temperature data from the temperature circuit.

17. The method for monitoring the bearing of the suction roller of claim 16, the method further comprising:
transmitting data based on the acceleration data from the positioning circuit and the temperature data from the temperature circuit to an external control unit that is external to the suction roller.

18. The method for monitoring the bearing of the suction roller of claim 15, the method further comprising:
receiving temperature data at a first port of the enclosure from a temperature sensor that is remote from the enclosure; and
transmitting data associated with the temperature from a second port of the enclosure to an external control unit.

19. The method for monitoring the bearing of the suction roller of claim 15, the method further comprising:
triggering an alert associated with faulty operation of the bearing of the suction roller based on the temperature associated with the bearing of the suction roller and a position of the bearing of the suction roller.

20. A bearing monitoring circuit for monitoring a suction roller, the bearing monitoring circuit comprising:
an accelerometer that is configured to monitor positioning of a bearing of the suction roller, and
a temperature circuit that is configured to monitor temperature of the bearing of the suction roller,
wherein the accelerometer and the temperature circuit are in a single enclosure that is mounted in the suction roller.
